(19) United States
(12) Patent Application Publication
(10) Pub. No.: US 2025/0313456 A1
(43) Pub. Date: Oct. 9, 2025

(54) Extraction of Antigravity Hydrogen Atoms

(71) Applicant: Hong Du, Rancho Cucamonga, CA (US)

(72) Inventor: Hong Du, Rancho Cucamonga, CA (US)

(21) Appl. No.: 18/626,332

(22) Filed: Apr. 4, 2024

(51) Int. Cl. C01B 3/00; C01B 3/50

(52) U.S. Cl. CPC C01B 3/0094; C01B 3/50; C01B 2210/0028; C01B 2210/0053

(57) ABSTRACT

This invention introduces practical procedures for concentration, purification and utilization of rare antigravitational hydrogen atoms created during early universe or later violent astronomical events following pair-production symmetry. A tall cryogenic concentration container maintains liquid hydrogen at extremely low, uniform and stable temperature with minimal convection and thermal diffusion. Rare molecules with zero gravity containing one rare antigravitational hydrogen atoms drift up and accumulate to the top by buoyancy. The concentrated zero-gravity hydrogen molecules are then chemically and/or physically broken down into individual atoms and recombined resulting in hydrogen molecules carrying normal gravity, zero gravity, and repulsive antigravity, respectively. When liquified and maintained in the cryogenic concentration container, the antigravitational hydrogen molecules are repelled to the top to be separated and purified. Cryogenic containers holding purified antigravitational liquid hydrogen can provide sustained levitation and propulsion for vehicles, aircrafts, space elevators, satellites, and spacecrafts consuming no fuel or energy.

### BACKGROUND OF THE INVENTION

Gravity is found to be always attractive for the very simple reason that only attractive force can help form stable celestial bodies, any macroscopic objects with repulsive antigravity will be repelled away beyond observation. But microscopically at elementary particle level, natural forces including gravity can always be attractive and repulsive symmetrically. This invention introduces practical procedures to concentrate and extract rare hydrogen atoms that carry repulsive antigravity from liquid hydrogen at extremely low temperature taking advantage of their negative weight. Hydrogen atoms created through pair-productions during early universe or in later violent astronomical events have equal probability to carry repulsive antigravity and attractive gravity following principles of symmetry in physics. However, only trace amount of antigravitational hydrogen atoms electrically bounded by atoms with common attractive gravity can exist in nature formed by dominant attractive gravity. Concentrated antigravitational hydrogen atoms can be used to further produce exclusively antigravitational liquid hydrogen through physicochemical procedures. Such antigravitational liquid hydrogen maintained in cryogenic containers can provide repulsive antigravity with magnitude equal to common gravity of regular liquid hydrogen but in opposite direction. The repulsive antigravity can be widely used to provide sustained antigravitational force for vehicles, aircrafts, space elevators and spacecrafts to achieve hovering or propulsion without fuel or power consumption.

### SUMMARY OF THE INVENTION

In this invention, regular hydrogen molecules are liquefied and stored in a tall cryogenic container maintained at uniform and extremely low temperature to minimize convection, thermal diffusion, and evaporation. Common hydrogen molecules comprise two common hydrogen atoms with normal weight, but trace portion of hydrogen molecules comprise one common hydrogen atoms along with one rare antigravitational hydrogen atoms whose antigravity cancels out the gravity of the common hydrogen atoms, resulting in rare weightless hydrogen molecules. Through gravitational buoyancy, rare weightless hydrogen molecules tend to drift to the top in liquid hydrogen mostly consisted of common hydrogen molecules and concentrate there over time. Top liquid can be collected and subjected to such gravitational separation recursively to enrich antigravitational hydrogen atoms. The enriched hydrogen molecules are then broken down into ions or single atoms and recombined back to hydrogen molecules through chemical and/or physical processes to statistically produce antigravitational hydrogen molecules that comprise exclusively antigravitational hydrogen atoms. These antigravitational hydrogen molecules can be easily extracted through the cryogenic liquification and gravitational separation processes because they are repelled by the Earth to float upwards.

Antigravitational hydrogen molecules naturally provide repulsive antigravity all by themselves with the same strength as common attractive gravity but in opposite direction. Moving parts, additional power or fuel consumptions are not required to generate the antigravity. Such property will revolutionarily liberate humanity from the constrains of gravity and achieve far-reaching goals in so many ways never seen before. For example, liquid antigravitational hydrogen can be widely and conveniently used to provide levitation for ground and marine transportation vehicles, aircrafts, space elevators, satellites and spacecrafts, or to provide sustained propulsion for deep space exploration beyond the Earth and solar system.

### BRIEF DESCRIPTION OF DRAWINGS

The drawings illustrate the conceptual schematics of this invention and might be implemented in different variations than the presented forms.

FIG. 1 is the schematics of a representative gravitational concentration setup, referred to as the concentration tower, to concentrate and extract rare weightless hydrogen molecules made of one rare antigravitational hydrogen atoms and one common hydrogen atoms with normal attractive gravity from regular liquid hydrogen by gravitational buoyancy.

FIG. 2 is the schematics of representative chemical processes for producing antigravitational hydrogen molecules containing exclusively antigravitational hydrogen atoms from concentrated weightless hydrogen molecules containing single antigravitational hydrogen atoms.

FIG. 3 is the schematics of representative physical processes for producing antigravitational hydrogen molecules containing exclusively antigravitational hydrogen atoms from concentrated weightless hydrogen molecules containing single antigravitational hydrogen atoms.

FIG. 4 is the illustration of vehicles, satellites, aircrafts and spacecrafts utilizing the repulsive antigravity provided by the liquid antigravitational hydrogen molecules.

FIG. 5 is the schematics of a practical space elevator that can be built to any high altitudes using liquid antigravitational hydrogen molecules to provide distributed elevation to counteract the weight of the elevator, eliminating the necessity of counterweight beyond geostationary altitude and the prohibitive stress caused by cumulative gravity inherent to conventional space elevator.

### DETAILED DESCRIPTION OF THE INVENTION

This invention describes the processes to concentrate rare hydrogen atoms carrying repulsive antigravity from regular liquid hydrogen and then produce purified antigravitational hydrogen molecules that can be liquefied and utilized to provide sustained antigravitational levitation without consuming power or fuel.

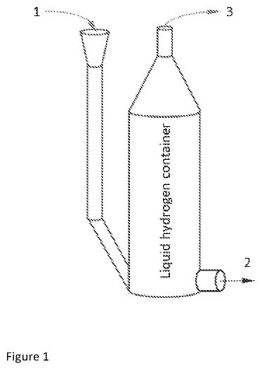

The schematics for the concentration tower is illustrated in FIG. 1. It is a tall and heat-insulated container that holds and maintains liquid hydrogen at cryogenic temperature. Regular liquid hydrogen is injected through member 1 through a pipe toward the bottom of the concentration tower and filled up to its capacity and sealed up. The liquid hydrogen is maintained at a uniform, stable and extremely low temperature to minimize vibration, convection, thermal diffusion and evaporation.

Most naturally occurring hydrogen atoms on Earth carry common attractive gravity, they are denoted by H₊; only a trace portion carry repulsive antigravity, they are denoted by H₋. The trace H₋ atoms were created during violent astronomical events such as the Big Bang, supernova explosion, galactic nuclei activity, or cosmic pair-production or spallation. Following principles of symmetry, 50% of newly created hydrogen atoms during pair-productions are H₋ atoms with the remaining 50% being common H₊ atoms. But during stellar evolution, most H₋ atoms were repelled away beyond observation by the repulsive antigravity while the attractive gravity helped the formation of celestial bodies. H₋ atoms do not tend to stay or accumulate in solar system because they are repelled by antigravity. But by definite though rare chances, a very small portion can be electromagnetically captured by other atoms such as H₊ and heavier atoms carrying common attractive gravity and retained in the solar system as rare H₋ atoms embedded in various chemical compounds that still exhibit overall non-repulsive and mostly attractive gravity. It is even possible that these trace H₋ atoms were later fused into larger atomic nuclei during stellar evolution and become rare antigravitational baryons (protons and neutrons) residing inside naturally occurring heavy atoms that still exhibit overall attractive gravity due to dominant common baryons carrying attractive gravity. If these naturally occurring heavy atoms experience nuclear reactions such as spallation, proton emission, fission or fusion, these rare antigravitational baryons can be ejected and form rare H₋ atoms. Therefore, nuclear reactors and high energy particle accelerators can also produce H₋ atoms through fission, spallation and pair production, but at extremely low efficiency and prohibitively high cost.

Regular liquid hydrogen consists mostly of common H₊ atoms in the form of H₊H₊ molecules carrying normal weight. Statistically, only a trace portion of H₋ atoms exist in the form of rare H₊H₋ molecules (H₋H₊ is the same as H₊H₋). H₋ atoms carry repulsive antigravity and cancel out attractive gravity from H₊ atoms, therefore the rare H₊H₋ molecules are virtually weightless. Inside the concentration tower, rare weightless H₊H₋ molecules tend to slowly drift up and accumulate in the top while common H₊H₊ molecules weight down and accumulate in the bottom. When convection and thermal diffusion are minimized by extremely low temperature, the ratio of H₊H₋ molecules in the top of the liquid will increase over time, and the concentrated H₊H₋ liquid can be extracted from member 3 while the depleted liquid hydrogen can be drained from member 2, and regular liquid hydrogen can be added through member 1 to continue the concentration and separation of H₊H₋. The concentrated liquid extracted from member 3 can be further concentrated recursively using another concentration tower until the ratio of H₊H₋ is adequate for the efficient production of H₋H₋ molecules.

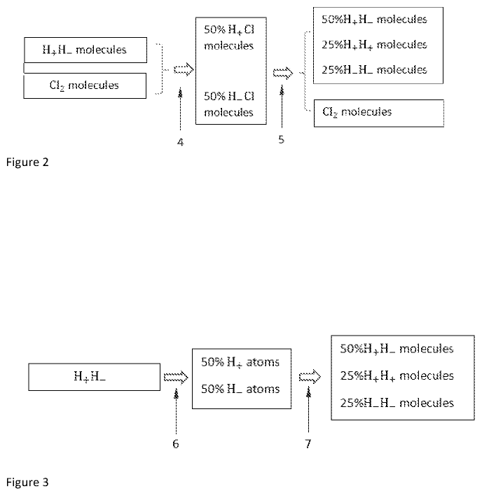

The H₊H₋ molecules in the concentrated top liquid are weightless but not yet antigravitational. The H₋ atoms in them need to be separated and reassembled to form H₋H₋ molecules to eliminate the weight from H₊ atoms before exhibiting repulsive antigravity, namely negative weight. FIG. 2 demonstrates a representative chemical process to produce H₋H₋ molecules from H₊H₋ molecules. Chemicals such as Cl₂ molecules can separate H₋ atoms from H₊H₋ molecules through chemical reaction as indicated by member 4, resulting in 50% H₋Cl and 50% H₊Cl molecules. These molecules can be electrolyzed to produce hydrogen molecules as indicated by member 5 and statistically resulting in 50% H₊H₋ molecules, 25% H₊H₊ molecules and 25% H₋H₋ molecules. The H₋H₋ molecules carrying negative weight can be easily separated from the rest when liquified by going through the concentration tower shown in FIG. 1 taking advantage of their distinctive repulsive antigravity. The remaining hydrogen molecules can be further concentrated and used to recursively produce and extract H₋H₋ molecules.

The H₊H₋ molecules can also be directly broken down into 50% H₃₀ and 50% H₋ atoms by physical methods as indicated by member 6 in FIG. 3 and then recombined to statistically produce H₋H₋ molecules as indicated by member 7. These methods include heating, electromagnetic radiation, ionization and particle collision. Over time, such process will asymptotically result in 50% H₊H₋ molecules, 25% H₊H₋ molecules and 25% H₋H₋ molecules. Again, the H₋H₋ molecules can be liquefied and gravitationally extracted utilizing the concentration tower shown in FIG. 1, and the remaining molecules can be further concentrated and used to recursively produce and extract H₋H₋ molecules.

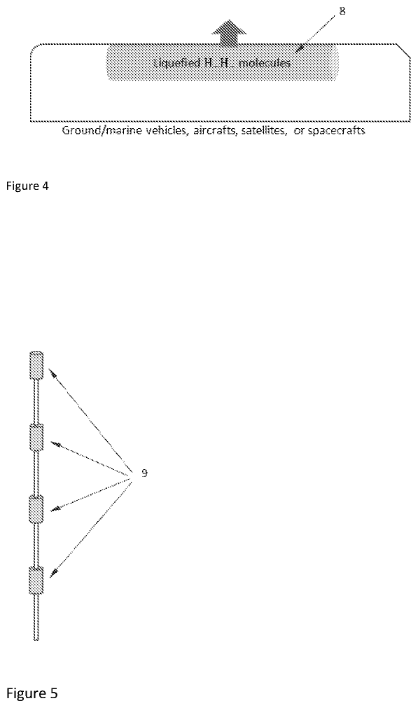

The liquefied pure H₋H₋ molecules produce repulsive antigravity with magnitude equal to that of regular hydrogen molecules (mostly H₊H₊ molecules) but in opposite direction. This revolutionary physical property can undoubtedly offer enormous benefits to humanity. For example, FIG. 4 demonstrates a typical utilization of liquefied H₋H₋ molecules as indicated by member 8 to partially or completely counteract the downward weight for ground or marine vehicles, aircrafts, satellites and spacecrafts by the upward repulsive antigravity carried by H₋H₋ molecules. Supported by the self-sustained repulsive antigravity, bulky and heavy aeronautic and supportive structures can be tremendously downsized, weight-induced frictions can be eliminated, these vehicles can hover above ground or water at any speeds at any altitudes with no fuel or power consumption and unconstrained by orbital speeds, takeoff and landing become unprecedentedly safer. Spacecrafts can become weightless by carrying adequate amount of antigravitational liquid hydrogen and reach any planets and celestial bodies unlimited by gravity with minimal cost compared to conventional means such as complicated rocket engines and exorbitant fuels. If desired, the spacecrafts can jettison appropriate amount of weight to enjoy spontaneous and sustained propulsion from the net repulsive antigravity, easily accelerating into deep space well beyond the solar system. Essentially, antigravitational property of H₋H₋ will revolutionize space travel and help accomplish arbitrary orbits by applying appropriate ratio of repulsive antigravity and regular weight.

FIG. 5 demonstrates the design of a practical space elevator that would otherwise be impossible without antigravity. The repulsive antigravity provided by the distributed liquid H₋H₋ as illustrated by member 9 counteracts the weight of the elevator segmentally throughout the entire length so that the stress from the weight of the elevator is evenly canceled out and does not accumulate as in conventional design. Consequently, ordinary materials can easily handle the residual stress and payload for the operation of the elevator. Such space elevator can be constructed to any desired heights because it does not require any centrifugal counterweight at the upper end well beyond geostationary orbit level.

Drawbacks of the utilization of liquid H₋H₋ include the necessity to maintain its cryogenic temperature although well designed heat insulation can significantly help. Chemically, H₋H₋ poses danger of potentially disastrous explosion. Another major downside is the low density of liquid H₋H₋, which is about 7% of the density of water. To overcome these shortcomings, H₋ atoms must be fused through nuclear reactions and transform to antigravitational atoms with much higher density and more favorable physical and chemical properties in solid state at room temperature, possessing the same physical and chemical properties as regular atoms except for the repulsive antigravity or negative weight. However, such nuclear reaction requires advanced technology beyond the scope of this patent.

There do theoretically exist objects in the universe that carry primarily repulsive antigravity relative to the Earth; however, they don't naturally occur within the solar system and the Milky Way galaxy since they would have been repelled by antigravity. The chance of harvesting them in space and bringing them back against repulsive antigravity is extremely impractical except for rare stray antigravitational asteroids that transiently wandered into the solar system. They typically exist astronomically far beyond reach and they are possibly antimatter that will annihilate with matter. If some debris with antigravity does approach the solar system by any chance, it will be promptly repelled along unusual orbits.

Naturally occurring atoms may also contain trace portion of antigravitational protons and neutrons. These trace antigravitational baryons can be ejected through fission or nuclear spallation and collected as trace H₋ atoms for further concentration. High energy particle accelerators can create H₋ atoms through pair-productions by energetic particle collision. These approaches are far too costly than concentration of H₋ atoms directly from naturally occurring hydrogen atoms.

1. Rare but naturally occurring trace hydrogen atoms carry repulsive antigravity, opposite to common attractive gravity. They are denoted as H₋. Most naturally occurring hydrogen atoms carry normal attractive gravity, they are denoted as H₊. Liquified hydrogen contains trace H₊H₋ molecules among mostly H₊H₊ molecules. H₊H₊ molecules carry normal weight, H₊H₋ molecules are weightless, giving trace H₊H₋ molecules strong buoyancy. When liquid hydrogen is maintained in a tall sealed cryogenic container at extremely low, stable and uniform temperature with minimal convection and thermal diffusion, rare H₊H₋ molecules will drift upward and concentrate over time. Concentrated H₊H₋ molecules can be extracted from the top liquid.

2. Concentrated H₊H₋ molecules can be chemically and/or physically broken down into H₋ and H₊ atoms and then chemically recombined to form hydrogen molecules as a mixture of H₋H₋, H₊H₋ and H₊H₊ molecules statistically. The H₋H₋ molecules carry repulsive antigravity or negative weight. When the mixture is liquified and stored in a sealed cryogenic container, liquid H₋H₋ molecules will float to the top of the container and can be easily separated to produce purified antigravitational H₋H₋ molecules.

3. Repulsive antigravity provided by H₋H₋ molecules especially in liquid from can offer sustained levitation and propulsion to counteract attractive gravity for a wide range of applications including ground/marine vehicles, aircrafts, space elevators, satellites and spacecrafts without consuming fuel or energy.
